(19) United States
(12) Patent Application Publication
(10) Pub. No.: US 2017/0113747 A1
(43) Pub. Date: Apr. 27, 2017

(54) ANTI-THEFT DEVICE FOR BICYCLES

(71) Applicant: Sang Woo KIM, Irvine, CA (US)

(72) Inventor: Sang Woo KIM, Irvine, CA (US)

(21) Appl. No.: 14/920,739

(22) Filed: Oct. 22, 2015

(51) Int. Cl. B62H 5/20; E05B 73/00

(52) U.S. Cl. CPC B62H 5/20; E05B 73/0017

(57) ABSTRACT

An anti-theft device for a bicycle includes a tilt sensor attached to the bicycle wherein the tilt sensor has a tilt switch to detect upright orientation of the bicycle; a microcontroller, electrically connected to the tilt sensor; a transceiver, electrically connected to the microcontroller, which wirelessly transmits or receives signals; a computing device to wirelessly receive or transmit the signals; and a software application installed on the mobile computing device. If the tilt sensor detects an upright orientation of the bicycle, it sends a signal for the upright orientation to the microcontroller and the signal is forwarded to the software application. Then, the software application sends a warning to a user through a user interface. If the tilt sensor detects an upright orientation of the bicycle, it sends a signal for the upright orientation to the microcontroller and the microcontroller activates a warning beep to emit a high-pitched sound.

### CROSS-REFERENCE TO RELATED APPLICATIONS

Not applicable.

### FIELD OF THE INVENTION

The present invention relates to an anti-theft device for bicycles and, more particularly, to a device for detecting and preventing bicycle theft using a tilt sensor which is attached to a bicycle.

### BACKGROUND OF THE INVENTION

A bicycle is a principal means of transportation in many regions and bicycling has become a popular leisure activity. A bicycle has two wheels attached to a frame, one behind the other, and a kick stand is usually used to park a bicycle.

Bicycles are often left in public areas and become easy target for theft. They are vulnerable for theft especially when they are not secured. Even if they are well secured, they may be quickly stolen using a breaking tool.

To prevent bicycle theft, a number of bicycle locking devices or anti-theft devices have been developed. However, thieves ere using tools to break such devices and bicycle theft is still common. When a bicycle is stolen, a bicycle owner may realize such theft too late and he may not be able to handle the situation effectively.

Tracking devices have been developed to track a stole bicycle; but such devices are expensive and generally have a complicated structure. In addition, they are not easy to install on a bicycle.

Therefore, to solve the above problems, a need for a device for detecting and preventing bicycle theft using a tilt sensor which is attached to a bicycle has been present for a long time considering the expansive demands in the everyday life. This invention is directed to solve these problems and satisfy the long-felt need.

### SUMMARY OF THE INVENTION

The present invention contrives to solve the disadvantages of the prior art. The present invention provides a device for detecting and preventing bicycle theft using a tilt sensor which is attached to a bicycle.

The object of the invention is to provide an anti-theft device for a bicycle, having a tilt sensor attached to the bicycle wherein the tilt sensor has a tilt switch to detect upright orientation of the bicycle; a microcontroller, electrically connected to the tilt sensor; a transceiver, electrically connected to the microcontroller, which wirelessly transmits or receives signals; a computing device to wirelessly receive or transmit the signals; and a software application installed on the mobile computing device.

Another object of the invention is to provide an anti-theft device for a bicycle, having a tilt sensor, a microcontroller, a transceiver, a computing device, and a software application. If the tilt sensor detects an upright orientation of the bicycle, it sends a signal for the upright orientation to the microcontroller which is then transmitted to the transceiver, to the computing device and then to the software application. Then, if the software application receives the signal for the upright orientation, the software application sends a warning to a user through a user interface.

Still another object of the invention is to provide an anti-theft device for a bicycle, having a tilt sensor, a microcontroller, a transceiver, a computing device, and a software application. If the tilt sensor detects an upright orientation of the bicycle, it sends a signal for the upright orientation to the microcontroller and the microcontroller activates a warning beep to emit a high-pitched sound.

The advantages of the present invention are: (1) the anti-theft device of the present invention sends a theft warning to a bicycle owner; (2) the anti-theft device of the present invention emits a high-pitched sound to prevent bicycle theft; (3) the anti-theft device of the present invention uses a tilt sensor, which is very inexpensive, to detect a bicycle theft; (4) the anti-theft device of the present invention is easy and inexpensive to manufacture; (5) the anti-theft device of the present invention has a simple but integrated structure; and (6) the anti-theft device of the present invention is easy to install.

Although the present invention is briefly summarized, the fuller under standing of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein;

FIG. 1 shows a schematic diagram illustrating the anti-theft device for bicycles according to one embodiment of the present invention;

FIG. 2 shows a schematic diagram illustrating a sensor unit according to one embodiment of the present invention;

FIG. 3 shows a schematic diagram illustrating a mobile device according to one embodiment of the present invention; and

FIG. 4 shows a sensor unit attached to a bicycle according to one embodiment of the present invention.

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a” “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

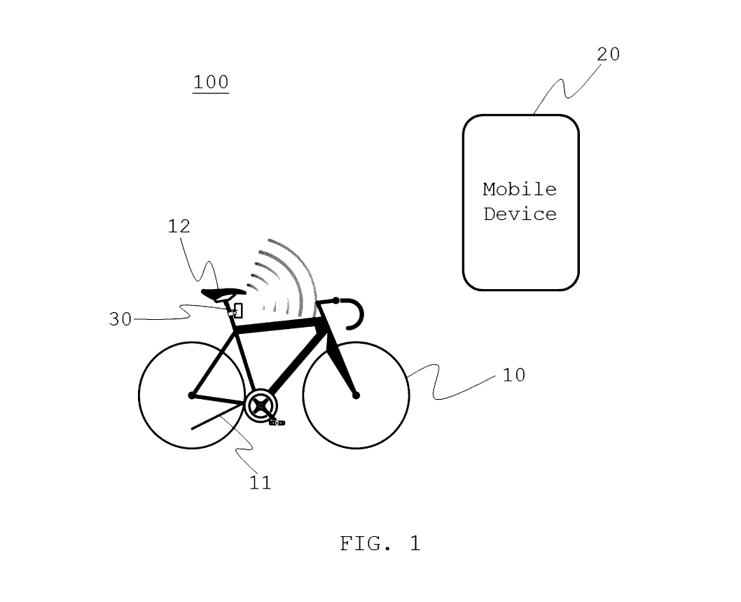

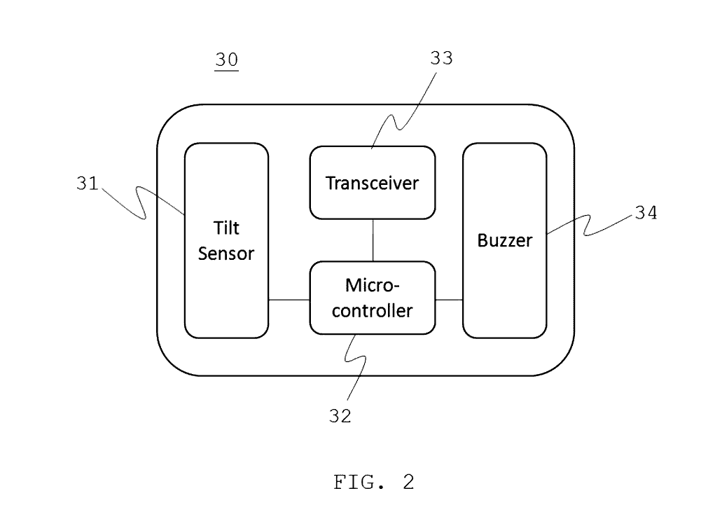

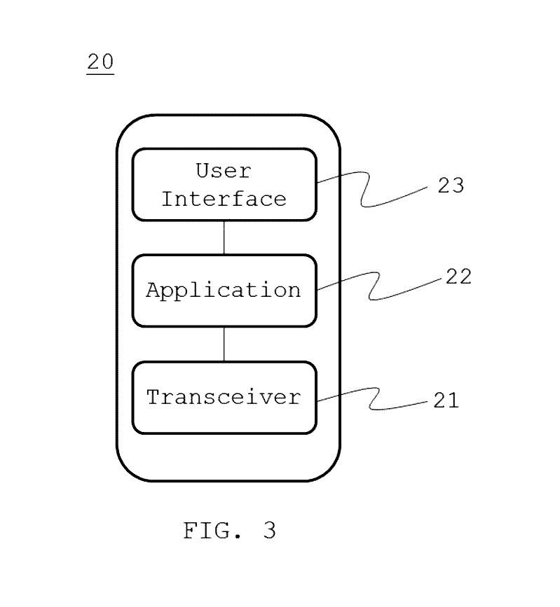

FIG. 1 shows a schematic diagram illustrating the anti-theft device 100 for bicycles 10 according to one embodiment of the present invention. FIGS. 2 and 3 respectively show a sensor unit 30 and a mobile device 20.

The anti-theft device 100 for a bicycle 10 comprises: a tilt sensor 31 attached to the bicycle 10 wherein the tilt sensor 31 has a tilt switch (not shown) to detect upright orientation of the bicycle 10; a microcontroller 32, electrically connected to the tilt sensor 31; a transceiver 33, electrically connected to the microcontroller 32, which wirelessly transmits or receives signals; a computing device 20 to wirelessly receive or transmit the signals; and a software application 22 installed on the mobile computing device 20.

A bicycle 10 has two wheels attached to a frame, one behind the other, and a kick stand 11 is usually used to park a bicycle 10. A kick stand 11, attached to a bicycle 10, lies horizontally when not in use and may be kicked into a vertical position to support the bicycle 10 when the bicycle 10 is stationary. The bicycle 10 is tilted when it stands on the kick stand 11, and to ride it, the bicycle 10 has to be back in upright position. Thus, the bicycle 10 changing from tilted position to upright position may mean the bicycle 10 is being stolen. Thus, the device 100 of the present invention sends a theft warning by detecting upright orientation of the bicycle 10. Here, upright orientation of the bicycle 10 means that the bicycle 10 is substantially in vertical position. Upright orientation of the bicycle 10 is when the bicycle 10 proceeds on its two wheels.

If a bicycle 10 has a double-leg kickstand, it is tiled when it stands on the double-leg kickstand, and the bicycle 10 is on upright position when it stands on its two wheels.

If the tilt sensor 31 detects an upright orientation of the bicycle 10, it sends a signal for the upright orientation to the microcontroller 32 and then, the signal is transmitted to the transceiver 33, to the computing device 20 and then to the software application 22. Once the software application 22 receives the signal for the upright orientation, the software application 22 sends a warning to a user through a user interface 23.

Tilt sensor is a device to detect the tilting of an object. Tilt sensor usually has on and off states and the state changes from on to off and vice versa if the sensor reaches a certain angle.

In one embodiment of the present invention, the tilt sensor 31 may be in an off state when the bicycle is tilted because it is supported by the kick stand 11, and the tilt sensor 31 may change to an on state when the bicycle is back in upright position. Once the sensor 31 is in an on state, it sends a signal to the microcontroller 32.

The computing device 20 may be a desktop computer, a laptop computer or other mobile computing devices such as a smart phone, a mobile phone, a tablet computer, a PDA (Personal Digital Assistant), or the like.

The computing device 20 includes a transceiver 21 to send and receive data or signals from the transceiver 33 of the sensor unit 30. The transceivers 21 and 33 wirelessly communicate with each other and the communication means may be Bluetooth™ communication module or other types of wireless communication module such as Bluetooth Low Energy (BLE), WiFi, band, wireless communication specification. Zig-bee, or the like.

If the tilt sensor 31 detects an upright orientation of the bicycle 10, it sends a signal for the upright orientation to the microcontroller 32 and the microcontroller 32 may activate a warning beep to emit a high-pitched sound. A user may deactivate the warning beep using the software application 22. The anti-theft device 100 may further comprise a buzzer 34 to emit the warning beep and the buzzer 34 is electrically connected to the micro controller 32.

The transceiver 33 and the computing device 20 may wirelessly communicate via a Bluetooth™ connection, Bluetooth™ low energy connection, Zigbee connection or WIFI connection.

Preferably, the transceiver 33 and the computing device 20 may wirelessly communicate via a Bluetooth™ connection. If a signal for the Bluetooth connection is below a certain level or lost, a warning may be issued by the software application 22 to a user. A Bluetooth™ received signal strength indicator (RSSI) may be used to detect the strength of the Bluetooth™ connection.

The anti-theft device 100 may further comprise an encryption module to encrypt and decrypt the signals being communicated between the transceiver 33 and the computing device 20.

In addition, a user may activate or deactivate the tilt sensor 31 by the software application 22. The computing device 20 may be a desktop, laptop, tablet computing device, mobile phone, cell phone, smart phone, PDA, or the like. Preferably, the computing device 20 is a mobile computing device, and more preferably, the computing device 20 is a smart phone or tablet computing device.

The anti-theft device may use a serial monitoring system in which the tilt sensor 31 sends signals of an orientation of the bicycle 10 at predetermined intervals to the microcontroller 32. If the tilt sensor 31 sends signals of the upright orientation of the bicycle for a predetermined time, the software application 22 may send a warning to a user through a user interface 23. Additionally, the microcontroller 32 may activate a warning beep to emit a high-pitched sound. The anti-theft device 100 may further comprise a buzzer 34 to emit such warning beep.

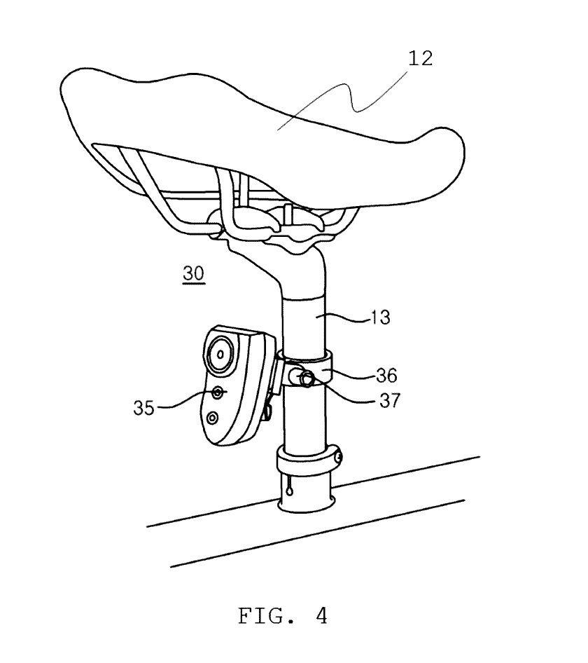

FIG. 4 shows a sensor unit 30 attached to a bicycle 10 according to one embodiment of the present invention.

The anti-theft device 100 may further comprise a housing 35 to house the tilt sensor 31, the microcontroller 32 and the transceiver 33. The housing 35 may further house a warning beep or a buzzer 34. The housing 35 is mounted, on the bicycle 10 by a clamp 36. Preferably, the clamp 36 is clamped to a seat post 13 of the bicycle 10. More preferably, the clamp 36 is clamped to the seat post 13 right below the saddle 12.

The housing 35 may be connected or joined to the clamp 36 by a hinge joint 37 so that the angle of the housing 35 can be adjusted with respect to the bicycle 10 to align the tilt sensor 31 to the upright orientation of the bicycle 10 in order for the tile switch to detect the upright orientation of the bicycle 10. As shown in FIG. 4, the housing 35 can rotate with respect to the hinge joint 37 in order to align the tilt sensor 31 with the direction where the earth's gravity pulls things when the bicycle 10 is in upright position. In order to align this way, the hinge joint 37 should be substantially perpendicular to the plane made by the bicycle 10. The hinge joint 37 is perpendicular to the longitudinal line of the tile sensor 31 as well.

The anti-theft device 100 may further comprise a buzzer 34 to emit a warning beep. In addition, the anti-theft device may further comprise a light to blink when the buzzer 34 emits a warning beep. The light may comprise LEDs (Light Emitting Diodes).

The anti-theft device 100 may further comprise a battery to supply electricity to the tilt sensor 31, microcontroller 32 and the transceiver 33.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An anti-theft device for a bicycle, comprising:
a tilt sensor attached to the bicycle wherein the tilt sensor has a tilt switch to detect upright orientation of the bicycle;
a microcontroller, electrically connected to the tilt sensor;
a transceiver, electrically connected to the microcontroller, which wirelessly transmits or receives signals
a computing device to wirelessly receive or transmit the signals;
a software application installed on the computing device, and
a housing to house the tilt sensor, the microcontroller and the transceiver, wherein the housing is mounted on the bicycle by a clamp,
wherein if the tilt sensor detects an upright orientation of the bicycle, the tilt, sensor sends a signal for the upright orientation to the microcontroller which is then transmitted to the transceiver, to the computing device and then to the software application,
wherein the tilt sensor sends signals of an orientation of the bicycle at predetermined intervals to the microcontroller,
wherein if the tilt sensor sends signals of the upright orientation of the bicycle for a predetermined time, the software application sends a warning to a user through a use interface and the microcontroller activates a warning beep to emit a high-pitched sound,
wherein the clamp is clamped to a seat post of the bicycle,
wherein the housing is connected to the clamp by a hinge joint so that an angle of the housing can be adjusted with respect to the bicycle to align the tilt switch to the upright orientation of the bicycle in order for the tilt switch to detect the upright orientation of the bicycle,
wherein the hinge joint is substantially perpendicular to a plane of the bicycle.

2. (canceled)

3. (canceled)

4. The anti-theft device of claim 1, wherein the user can deactivate the warning beep using the software application.

5. The anti-theft device of claim 1, wherein the transceiver and the computing device wirelessly communicate via a Bluetooth connection, Bluetooth low energy connection, Zigbee connection or WIFI connection.

6. The anti-theft device of claim 5, wherein the transceiver and the computing device wirelessly communicate via the Bluetooth connection.

7. The anti-theft device of claim 6, wherein if a signal for the Bluetooth connection is below a certain level or lost, a warning is issued by the software application to a user.

8. The anti-theft device of claim 1, wherein a user can activate or deactivate the tilt sensor by the software application.

9. The anti-theft device of claim 1, further comprising an encryption module to encrypt and decrypt the signals.

10. The anti-theft device of claim 1, wherein the computing device is a desktop, laptop, tablet computing device, mobile phone, cell phone, smart phone, or PDA.

11. The anti-theft device of claim 1, wherein the computing device is a mobile computing device.

12. The anti-theft device of claim l, wherein the computing device is a smart phone or tablet computing device.

13. (canceled)

14. (canceled)

15. (canceled)

16. (canceled)

17. (canceled)

18. The anti-theft device of claim 1, further comprising a buzzer to emit the warning beep.

19. The anti-theft device of claim 18, further comprising light to blink when the buzzer emits the warning beep.

20. The anti-theft device of claim 19, wherein the light comprises LEDs.
